(19) United States
(12) Patent Application Publication
(10) Pub. No.: US 2006/0053451 A1
(43) Pub. Date: Mar. 9, 2006

(54) Method and system for providing a cache guide

(76) Inventors: Terry Wayne Lockrige, Indianapolis, IN (US); Ting Wang, Kokomo, IN (US); Robert Eugene Trzybinski, Indianapolis, IN (US)

Correspondence Address: THOMSON LICENSING INC., PATENT OPERATIONS, PO BOX 5312, PRINCETON, NJ, 08543-5312, US

(21) Appl. No.: 10/526,530

(22) PCT Filed: Jun. 9, 2003
(86) PCT No.: PCT/US03/17985

§ 371 Date: Mar. 2, 2005

Related U.S. Application Data
(60) Provisional application No. 60/408,436, filed on Sep. 5, 2002.

(51) Int. Cl. H04N 5/445; G06F 13/00; G06F 3/00

(52) U.S. Cl. 725/50; 725/39

(57) ABSTRACT

A method and system for providing a cache guide to a client. The cache guide containing a subset of available guide data. The available guide data being locally stored in a Mini-Headend unit and the subset being stored in the cache memory of a remote set-top box.

### FIELD OF THE INVENTION

The present invention relates to providing video services in a Multi-Dwelling or Multi-Tenant network.

### BACKGROUND OF THE INVENTION

In conventional video systems (e.g., satellite, cable, etc . . . ) the content provider offers a program guide (which lists channel IDs, program titles, program description and the like) to clients on the system. Traditionally, the entire program guide is stored on the consumer premises equipment device (e.g., set-top box) in the dwelling unit of each client. However, one drawback to this approach is that the program guide is often very large (e.g., 6 MBs). Therefore, the CPE device needs to have a relatively large memory and needs to allocate a large portion of the memory for storage of the program guide. The present invention is directed towards overcoming this drawback.

### SUMMARY OF THE INVENTION

The present invention limits the memory requirements in a network set top box to reduce the overall system cost by using a smaller memory to collect a portion of a guide and the whole guide resides on an accessible network. More specifically, the present invention is directed towards a method and system for providing a cache guide to a client. The cache guide containing a subset of available guide data. The available guide data being locally stored in a Mini-Headend unit and the subset being stored in the cache memory of a remote set-top box.

### BRIEF DESCRIPTION OF THE DRAWINGS

In the drawings:

FIG. 1 is an exemplary system diagram of the present invention; and

FIG. 2 is a flow chart illustrating the program guide caching process of the present invention.

The characteristics and advantages of the present invention will become more apparent from the following description, given by way of example.

### DETAILED DESCRIPTION OF THE PREFERRED EMBODIMENT

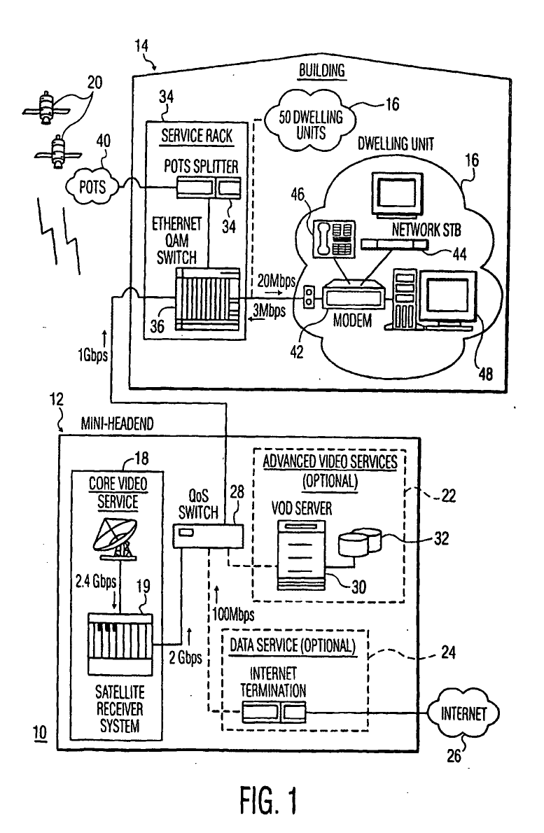

Referring now to FIG. 1, an exemplary system 10 that operates according to the principles of the present invention is shown. System 10 is an integrated digital data system to provide broadband, digital video, and services to multiple users. More specifically, system 10 integrates quality audio and video with digital IP data services for multiple users. This system design provides a platform to launch a variety of cost effective digital services. System 10 is designed to be scalable, so different digital data services can be added incrementally.

System 10 includes a Mini-Headend Unit 12 where digital audio, video, and data services are received, aggregated together and distributed, and a Multi-Dwelling Unit and/or Multi-Tenant Unit (“MxU”) network 14. Network 14 may be located in one or more apartment buildings, hotels, or any other structure where multiple clients desiring digital audio, video, and data services reside.

Mini-Headend Unit 12 is responsible for receiving data, providing Quality of Service (“QoS”), providing customized services, and routing data to dwelling units 16 in the MxU network 14. Mini-Headend unit 12 includes a Core Video Service System 18, an Advanced Video Services System 22, a Data Service System 24 communicatively connected to the Internet 26, and a QoS switch 28.

Core Video Service System 18 preferably includes a Satellite Receiver System 19 communicatively connected to satellites 20. Satellite Receiver System 19 is able to scale the number of streams received from satellites 20 in accordance with the number of clients desiring service. More specifically, Satellite Receiver system 18 runs a multi-cast server to allow network set top boxes 44 in the dwelling units 16 to request digital data streams. Satellite Receiver system 18 scales by the number of tuning blades in the chassis until all transponders for the satellite are being received. A fully loaded chassis having 60 transponders is able to handle an input data rate of 2.4 Gbps. At this point, the chassis is able to handle n users by accepting a new user request to the appropriate multi-cast group. Satellite Receiver System 19 is able to receive satellite signals and output IP packets at a data rate of 2 Gbps to multi-cast aware switch 28. More specifically, The IP packets that are sent out use QoS (as set forth in standards IEEE 802.1p (entitled “Traffic Class Expediting and Dynamic Multicast Filtering”) and IEEE 802.1q (entitled “Virtual LANs”)) to insure that the packets are delivered promptly. The network interface on the Satellite Receiver System 19 is a 1 Gbps Ethernet port and is expandable to two 1 Gbps Ethernet ports. A management system of the Satellite Receiver 19 accepts requests for programs from clients. The management system allows clients to select a satellite, transponder, and program IDs, and allows the Satellite Receiver System 19 to provide specific program streams to the client. The management system also supports multi-casting to save bandwidth. Although satellite receiver system 19 and satellites 20 are illustrated as the content delivery medium in FIG. 1, the use of other media (e.g., cable, fiber, etc.) for delivering content is considered within the scope of the invention.

Advanced Video Services system 22 is a platform that works in conjunction with the Satellite Receiver 19 to enable additional digital video services. Advance Video Services system 22 is scaled according to the number of clients using the service. For example, system 22 may require more servers 30 as the number of clients increases. The types of services provided are, inter alia, Video On Demand, Near Video On Demand, Limited Video On Demand, Nielsen Ratings, Time Shift, Auto Record, Personal Video Recording (“PVR”), and the like. Advanced Video System 22 includes a Conditional Access System (not shown) that is used for program streams that are recorded to hard drive(s) 32. When recording, the original program stream received from Satellite Receiver System 19 is decrypted, picture data is extracted, and a new program stream (containing the extracted picture data) is encrypted and stored onto hard drive(s) 32. The network provider's conditional access system is terminated at the Advanced Video System Server 30 and the new conditional access system is used thereafter.

Data Service System 24 is scaled according to the number of clients using internet service and the required speed or bandwidth of the internet service.

Mini-Headend unit 12 may include a Gigabit QoS Ethernet switch 28 (necessary for medium to large systems) that is scalable and can be removed in small installations. As known by those skilled in the art, some of the issues that are considered when selecting switch 28 are the type of services provided and how many dwelling units 16 in MxU network 14 need to be supported. Switch 28 provides connectivity between Satellite Receiver System 19, Advance Video Services system 22 and Data Services System 24. Switch 28 also provides connectivity from the Mini-Headend unit 1-2 to the MxU network 14. Switch 28 supports full-duplex Gigabit Ethernet interfaces and is scalable to support systems of various sizes. Switch 28 supports the QoS set forth in the IEEE 802.1p and 802.1q standards. Having QoS facilitates the communication between switch 28 and Advanced Video Services System 22 and Data Services System 24. More specifically, video data from Video Services system 18 and Advanced Video Services system 22 is given a higher priority than data from Data Service system 24. For example, when video data and internet data is simultaneously requested, video data is transmitted first and the internet data is either transmitted simultaneously if enough bandwidth is available or transmitted at a later time when sufficient bandwidth becomes available.

MxU network 14 includes a service rack 34 and dwelling units 16. Service rack 34 is scalable according to the number of dwelling units 16 in the MxU network 14 and is located in the central point where the phone lines in the MxU network 14 come together. The number of MxU networks 14 in system 10 dictates the number of service racks 34 required. Preferably, a service rack 34 is provided for each network 14 (e.g., building) in a multi-network environment (e.g., a multiple building complex). Each service rack 34 includes a VDSL switch 36 that uses a Plain Old Telephone Service (“POTS”) Splitter 38 to combine POTS service 40 with the digital video, audio, and data received from the QoS switch 28 of Mini-Headend 12 via a 1 Gbps phone line. Although VDSL switch 36 is illustrated as being an Ethernet QAM switch, it should be noted that the use of any other Ethernet switch is considered within the scope of the present invention.

In system 10 each Dwelling Unit 16 that has subscribed to digital services is required to have a consumer premises equipment (“CPE”) device. The CPE device for a given dwelling unit 16, depending on the client's service subscription, may include a modem 42, a network set top box (“STB”) 44, both a modem 42 and a STB 44, or an integrated modem and STB unit (not shown). The exemplary system 10 of the present invention requires at least the modem 42 for the reception of digital data, audio, and video services. Modem 42 is connectable to switch 36 via phone lines and terminates the VDSL line. Modem 42 also has a POTS Splitter (not shown) and a connection for phone services 46. Modem 42 has an Ethernet port to provide computers 48 internet access and network STBs 44 access to audio and video services.

Although phone lines are shown as being used as the communication medium between the dwelling units 16 and the Mini-Headend unit 12, cable and wireless networks are considered within the scope of the invention.

In summary, system 10 provides the architecture to deliver, inter alia, digital audio, digital video, high-speed Internet access, telephony services, security services, and the like to a client residing at a dwelling unit 16, and provides a revenue stream and a platform to add incremental or new services to the system provider.

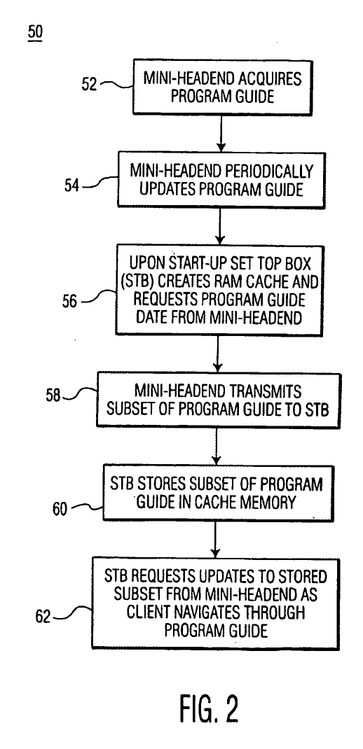

Referring now to FIG. 2, a program guide caching process 50 is shown. Upon startup of system 10 the Mini-Headend unit 12, at step 52, acquires a program guide from Core Video Service system 18. It should be noted that in some cases the guide can be greater than 6 Mbytes and could require scanning multiple channels or transponders to collect the whole guide. Mini-Headend unit 12 stores the program guide locally and, at step 54, periodically updates the program guide when new guide data is provided by the Core Video Service system 18. After a network STB 44 boots up the STB 44, at step 56, creates a ram cache and requests program guide data from Mini-Headend unit 12. In response to the request, Mini-Headend unit 12, at step 58, transmits a subset of the locally stored program guide to STB 44. The subset holds enough information to permit the client to select different channels and provides a detailed snapshot around the channel currently being viewed. STB 44, at step 60, stores the received subset in its cache memory. Afterwards, STB 44, at step 62, will request updates to the stored program guide subset from Mini-Headend unit 12 as the client navigates through the program guide, switches channels, and the like. Since the Mini-Headend unit 12 maintains a complete and current program guide the response to update requests is much quicker than if the STB 44 had to collect such updates by scanning the program streams, channels, and/or transponders of the Core Video Service system 18.

It should be noted that the program guide stored by Mini-Headend unit 12 can be augmented with additional information (e.g., program data, video clips, etc . . . ) acquired from the internet 26 via Data Service system 24.

Although the present invention has been described in conjunction with the embodiments disclosed herein, it should be understood that the foregoing description is intended to illustrate and not limit the scope of the invention as defined by the claims.

1. A method for providing a program guide, the method comprising the steps of:
acquiring program guide data from a content provider;
locally storing the acquired program guide data;
transmitting a subset of the locally stored program guide data to a remote terminal;
receiving a request for an update to the subset from the remote terminal;
accessing the locally stored program guide to create the requested update; and
transmitting the update to the remote terminal.

2. The method of claim 1 wherein the remote terminal is a set-top box.

3. The method of claim 1 wherein the update request is generated due to a channel change.

4. The method of claim 1, wherein the subset of the locally stored program guide data contains channel IDs for all the channels in the locally stored program guide and detailed program information for one of the channels in the locally stored program guide.

5. The method of claim 1, further comprising the steps of:
periodically acquiring updates to the program guide data from the content provider; and
altering the locally stored program guide data such that the locally stored program guide conforms to the updates.

6. The method of claim 5, further comprising the step of:
transmitting a new subset to the remote terminal if an update received from the content provider altered data in the locally stored program guide data that was included in the subset previously transmitted to the terminal.

7. A method of providing a program guide, the method comprising the steps of:
allocating a cache memory for storage of a subset of program guide data;
acquiring the subset of program guide data;
storing the subset of program guide data in the cache memory; and
processing the stored subset of program guide data to create a program guide.

8. The method of claim 7, further comprising the step of:
displaying the program guide to a client.

9. The method of claim 7, further comprising the steps of:
receiving a channel change request from a client;
requesting a second subset of program guide data;
receiving the second subset of program guide data; and
storing the second subset of program guide data in the cache memory.

10. The method of claim 7, wherein the program guide data is remotely stored in a Mini-Headend unit.

11. A system for providing a program guide, the system comprising:
means for acquiring program guide data from a content provider;
means for locally storing the acquired program guide data;
means for transmitting a subset of the locally stored program guide data to a remote terminal;
means for receiving a request for an update to the subset from the remote terminal;
means for accessing the locally stored program guide to create the requested update; and
means for transmitting the update to the remote terminal.

12. The system of claim 11 wherein the remote terminal is a set-top box.

13. The system of claim 11 wherein the update request is generated due to a channel change.

14. The system of claim 11, wherein the subset of the locally stored program guide data contains channel IDs for all the channels in the locally stored program guide and detailed program information for one of the channels in the locally stored program guide.

15. The system of claim 11, further comprising:
means for periodically acquiring updates to the program guide data from the content provider; and
means for altering the locally stored program guide data such that the locally stored program guide conforms to the updates.

16. The system of claim 15, further comprising:
means for transmitting a new subset to the remote terminal if an update received from the content provider altered data in the locally stored program guide data that was included in the subset previously transmitted to the terminal.

17. A system for providing a program guide, the system comprising:
means for allocating a cache memory for storage of a subset of program guide data;
means for acquiring the subset of program guide data;
means for storing the subset of program guide data in the cache memory; and
means for processing the stored subset of program guide data to create a program guide.

18. The system of claim 17, further comprising:
means for displaying the program guide to a client.

19. The system of claim 17, further comprising:
means for receiving a channel change request from a client;
means for requesting a second subset of program guide data;
means for receiving the second subset of program guide data; and
means for storing the second subset of program guide data in the cache memory.

20. The system of claim 17, wherein the program guide data is remotely stored in a Mini-Headend unit.
